(19) United States
(12) Patent Application Publication
(10) Pub. No.: US 2012/0054494 A1
(43) Pub. Date: Mar. 1, 2012

(54) METHOD FOR SECURING A GADGET ACCESS TO A LIBRARY

(76) Inventors: Vincent Hiribarren, Nozay (FR); Julien Robinson, Nozay (FR)

(21) Appl. No.: 13/144,770

(22) PCT Filed: Dec. 28, 2009
(86) PCT No.: PCT/EP2009/067964

§ 371 Date: Nov. 1, 2011

(30) Foreign Application Priority Data
Jan. 16, 2009 (EP) 09305038.3

(51) Int. Cl. H04L 9/00

(52) U.S. Cl. 713/176

(57) ABSTRACT

The invention relates to a method for securing the operation of a gadget requiring access to features hosted in a library of a gadget container (36) in order to implement these features into a primary file (35) of such gadget, the primary file (35) being sent by a Web hosting server (40) to the gadget container (36) to allow the implementation of the features with the primary file (35), wherein: —the gadget container (36) retrieves the primary file (35) of the gadget from the Web hosting server (40) with a signature (16), based on a public key/private key encryption system, associated therein,—the gadget container (36) verifies, with a public key of the public/private key encryption system, the signature (16) associated to the gadget primary file, —the gadget container (36) decides to authorize or to refuse the implementation of its library (44) features depending on whether the signature (16) associated with the primary file (35) is accepted or refused.

The invention relates to a method for securing a gadget access to a library.

The World Wide Web, thereafter referred to as the “Web”, is a system of interlinked hypertext pages which can be accessed through the Internet.

More precisely, a user can operate a Web browser to display on his/her computer Web pages which are stored in a distant Web server.

For that purpose, the Web browser downloads the code source of such Web pages, via the Internet, from the Web server to the computer. Such Web pages may contain multimedia data—such as text, images and videos—and/or provide access to applications. Also, Web pages generally allow navigating between them using hyperlinks.

Specific technologies have been developed in order to increase inter-connectivity and interactivity in the Web-delivered contents, such technologies being commonly named Web 2.0.

The Web 2.0 allows users not only to retrieve applications and/or information—as the in prior Web—but also to participate in their creation and/or development.

In this context of the Web 2.0, portable software programs called “gadgets” or “widgets” have been developed to provide end users with applications that can be installed and executed within Web pages.

Practically, Web gadgets are files based on eXtensible Markup Language (XML), a general-purpose specification allowing the creation of marked-up languages such as the eXtensible HyperText Markup Language (XHTML).

Gadgets also use XHTML elements, metadata and scripting languages such as JavaScript , in order to access objects embedded in other applications.

To operate a gadget, a Web browser needs to download the gadget from a specific server, thereafter called gadget container, which stores features to be implemented in an XML file of the gadget, called thereafter primary file.

More precisely, the gadget container requests the transmission of the gadget XML file to a Web hosting server and, after reception, implements the features within such XML or primary file.

Gadgets are created by independent developers but, to provide some compatibility, the features to be implemented therein have been defined and/or standardized de facto. Thereafter, a set of features define to run a gadget is called a library. Thus, a developer using such features—typically JavaScript® interfaces or API—in the operation of a widget has the assurance that the widget can be implemented through any container complying with these given features.

As an example, a special feature allows to check for the presence of another feature in a container: gadgets.util.hasFeature(feature name) Nevertheless, a problem with gadget development lies on the possibility to develop a gadget in order to spam users. If, for instance, a service provider provides a new standard feature allowing a gadget to send e-mails or launch phone calls, a spam developer can try to create a gadget which would wrongly use that feature to spam users.

A proposed solution for that problem might be to limit access to libraries in order to avoid the operation of a spamming gadget, for instance by limiting its use for a limited number of operations. Nevertheless, this limitation does not allow the development of gadgets to be hosted anywhere, and copied by anyone, according to the gadget development philosophy. It would also restrain gadgets' development even if specific developers are known to be trustworthy and/or even if gadgets' code was deeply checked by the gadget container owner.

The present invention aims to solve such problem by providing a method which allows both public access to gadget development and enhanced security on gadget operations.

For that purpose, the invention relates to a method for securing the operation of a gadget requiring access to features hosted in a library of a gadget container in order to implement these features into a primary file of such gadget, the primary file being sent by a Web hosting server to the gadget container to allow the implementation of the features with the primary file, wherein:
the gadget container retrieves the primary file of the gadget from the Web hosting server with a signature, based on a public key/private key encryption system, associated therein,
the gadget container controls, with a public key of the public/private key encryption system, the signature associated to the gadget primary file,
the gadget container decides to authorize or to refuse the implementation of its library features depending on whether it accepts or refuses the signature associated with the primary file.

A method according to the invention delivers a light and transparent service agreement for the use of specific features stored in gadget containers while keeping the ease of programming gadgets through open standards.

Thus the invention is fully compatible with gadget's approach since the gadget is not encrypted but rather signed, so that everyone can examine its code to develop it and/or to use it.

In one embodiment, the signature associated to the primary file derives from an encryption, with a private key of the public/private key encryption system, of an identifier depending on the primary file code.

In one embodiment, the identifier depending on the primary file code is a Hash function of the primary file.

In one embodiment the gadget container decides to authorize the access to the features of the library when it both identifies the authorized private key as an authorized private key and establishes the integrity of the primary file.

In one embodiment the gadget container decides to refuse the access to the library features if either:
the private key is not recognized, or
the private key is not authorized, or
the integrity of the primary file is not established.

In this case, a message indicating a lack of authorization may be transmitted to the Web browser requesting to operate the gadget.

In one embodiment the feature is dynamically generated depending on an IP address associated to a request for operating the gadget.

In one embodiment, the authorization for access is given for a certain lack of time.

In one embodiment, the primary file is an XML file and the features comprise Javascript® code.

The invention also relates to a gadget container hosting features to be implemented into a primary file of a gadget, such primary file being received from a Web hosting server upon request by the gadget container, wherein the gadget container comprises:
Means for retrieving the primary file of the gadget with a signature, based on public/private key encryption system, associated therein,
Means for controlling, with a public key of the public/private key encryption system, the signature associated to the gadget primary file,
Means for authorizing or refusing the access to the library's features depending on whether it accepts or refuses the signature associated within the primary file, in order to implement a method according to any of the previous embodiments.

The invention also relates to a gadget primary file requiring access to features hosted in a library of a gadget container in order to implement these features for its operation, wherein it comprises a signature, based on public key/private key encryption system, associated therein in order to implement a method according to any of the previous embodiments.

The foregoing aspects and many of the attendant advantages of this invention will become more readily appreciated as the same becomes better understood by reference to the following detailed description when taking in conjunction with the accompanying drawings wherein:

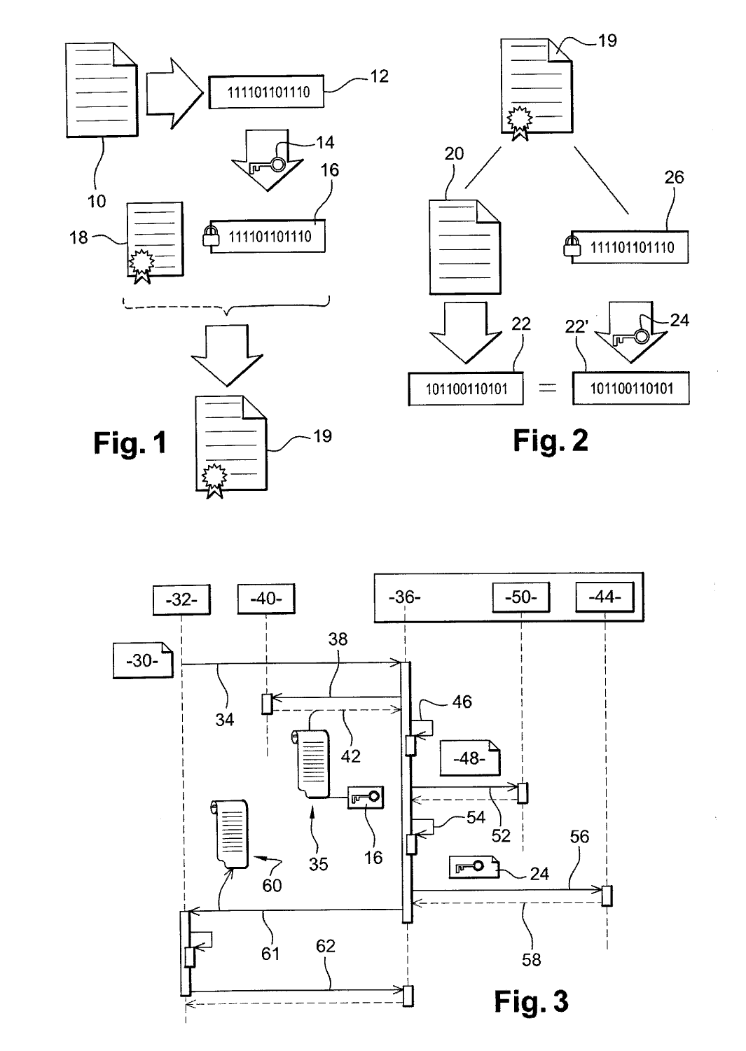

FIGS. 1 and 2 represent the operation of a public/private key system for digital signature as used in the invention, and

FIG. 3 represents a sequence of operations in a method according to the invention.

In reference to FIGS. 1 and 2, the essential aspects of a signature through public-key cryptography, also known as asymmetric cryptography, are represented.

In one application of this form of cryptography, any of a plurality of different private keys can be used to encrypt a file while a public key can be used to identify which private key was used to encrypt the file.

For that purpose, public and private keys are codes mathematically related whereby the private key code cannot be practically derived from the public key code while the public key can be used to decrypt private key based encryptions.

Further, private key signature requires a file treatment to get an identifier 12 of this file 10 —for example its Hash function—that a private key 14 encrypts thereafter.

Thereafter, the encrypted signature 16 of the file 10 is obtained by encrypting the identifier 12 with the private key 14. To finish with, a certificate 18 is joined to the encrypted signature 16 and to the file 10 in order to identify a public key 24 which should be used thereafter to verify the signature of the signed file 19.

For that purpose, the signed file 19 (FIG. 2) is treated in order to retrieve both a file 20 and an encrypted signature 26 so that an identifier 22—its Hash function according to this example—is derived from this file 20 and so that the public key 24 decrypts the signature 26 to obtain an identifier 22′ —its Hash function according to this example.

If identifiers 12, 22 and 22′ are identical, it is established that the file 20 corresponds to the file 10—integrity condition—and that it was signed by a private key 14 which can be identified—identification condition.

Such signature identification process is used in this embodiment of the invention wherein a private key is used to incorporate a signature into a gadget code. More precisely, a private key is used to encrypt an identifier of such gadget code, as its Hash function, as previously described in reference to FIG. 1. For instance, such signature may appear under a heading “Signature” in the primary or XML code of a gadget as in the following sequence:

<?xml version=″1.0″ encoding=″UTF-8″ ?>
<Module>

<ModulePrefs title=″Hello world example″>

<Require feature=″restrictedLibrary″/>
<Signature keyId=″EtPPe87EdE33Mqs″>

iQCVwUBNl6/9rgiQr+16we9AQExEQP/esoaFA/wLiYrhrfBJqGnMJZRI3WI8jZ/f2fMU3qPfO
WGkOoyZBujsq1kMEaxai4m+WqaXlemZdsQFaiRxaJTcrE1Sv+8DeaNTQIgMila/Cp/d1ZGj
YkgbfFdat/Y8iualJFiEddMK2L/Mf0hhSo1ozSmxizYY1U

</Signature>

</ModulePrefs>

<Content type=″html″>

<![CDATA[ <div id=”data”></div>

<script type=″text/javascript″>

restrictedLibrary.action( );

</script>

]]>

</Content>

</Module>

It is underlined that various parameters given in this example—e.g. the name of the XML tag, its emplacement in the XML stream, the kind of signature, the type of gadget specification—do not limit the scope of the invention since they can vary depending on the gadget to be signed.

With a private signature associated to its code, a gadget file can be identified by a gadget container in order to control its access to a hosted features following the sequence of operations explained hereunder in reference to FIG. 3 where references used in FIGS. 1 and 2 may be used to refer to private/public keys.

To start with a gadget operation, a Web browser 32 requests, upon activation of an HTML iframe tag 30 associated to a gadget, the donwloading of such gadget. For instance, the iframe tag may appear as:

<iframe src=“http://shindig.alea.net/gadget?url=http:/ /repository.gadgetcom/shadok.xml”>

Once the iframe 30 leads the Web browser 32 to send a request 34 to a container 36 hosting features for such gadget, the gadget container 36 sends a request 38 to a Web hosting server 40 in order to get an XML file 35 of the gadget, such XML file being also called hereunder primary file.

Web hosting server 40 sends—step 42—the primary file 35 to the gadget container 36 in order to have this primary file 35 implemented with retrieved features from the library 44 of the gadget container 36.

According to the invention, the gadget container 36 operates a first control 46 to determine if an authorization 48 is required to access the library 44 for such features.

If this is the case, the gadget container 36 operates a second control 52 through a controller 50 in order to ensure that the gadget XML file comprises a reference to a public key authorized by the gadget container.

If this is also the case, the gadget container 36 operates a third control 54 in order to ensure that the gadget XML file 35 comprises a valid signature 16, i.e. a signature referenced by the gadget container 36. This control is operated as already described in reference to FIG. 2.

If the public key 24 succeeds in identifying an authorized private key 14 and in recognizing the integrity of the primary file, the gadget container 36 operates a request 56 to its library 44 in order to get the required features of the library in return 58, generally JavaScript implementing code.

Therefore, an active gadget code 60 can be sent—step 61—to the Web browser 32 in order to have it operating the gadget, namely by processing its JavaScript code.

If the gadget does not reference a correct public key (control 52) or does not comprise an accepted private key or fails to prove integrity (control 54), the gadget container 36 stops the process for getting an authorization to access the library 44 and delivers a message of lack of authorization for that gadget to get access to the library.

It must be underlined that a Markup Language Web based page can be a HTML-base web page but also any kind of XML document and/or a derived application therefrom such as SGML for Standard Generalized Markup Language.

The invention can be derived in related embodiments within the scope of the claimed invention. For instance, identification signatures associated to a gadget may be stored and referenced in a database, the gadget code comprising a reference to the database instead of a signature.

According to the embodiments, the feature to be implemented in the primary file of the widget might be dynamically generated depending on an IP address of the Web server and/or a given authorization for access is given for a certain period of time so that a further query 62 for gadget features during this period is automatically accepted without library access control.

1. Method for securing the operation of a gadget requiring access to features hosted in a library (44) of a gadget container (36) in order to implement these features into a primary file (35) of such gadget, the primary file (35) being sent by a Web hosting server (40) to the gadget container (36) to allow the implementation of the features with the primary file (35), wherein:
the gadget container (36) retrieves the primary file (35) of the gadget from the Web hosting server (40) with a signature (16), based on a public key (24)/private key (14) encryption system, associated therein,
the gadget container (36) controls, with a public key (24) of the public/private key encryption system, the signature (16) associated to the gadget primary file,
the gadget container (36) decides to authorize or to refuse the implementation of its library (44) features depending on whether the signature (16) associated with the primary file (35) is accepted or refused.

2. Method according to claim 1 wherein the signature associated to the primary file (35) derives from an encryption, with a private key (14) of the public/private key encryption system, of an identifier (12) depending on the primary file (35) code.

3. Method according to claim 2 wherein the identifier (12) depending on the primary file (35) code is a Hash function of the primary file (35).

4. Method according to claim 1 wherein the gadget container (36) decides to authorize the access to the library (44) features when it both identifies the authorized private key (14) an authorized private key and establishes the integrity of the primary file (35).

5. Method according to claim 1 wherein the gadget container (36) decides to refuse the access to the library features (44) if either:
the private key (14) is not recognized, or
the private key (14) is not authorized, or
the integrity of the primary file (35) is not established.

6. Method according to claim 5 wherein a message indicating a lack of authorization is transmitted to the Web browser (32) requesting to operate the gadget.

7. Method according to claim 1 wherein the feature is dynamically generated depending on an IP address associated to a request (34) for operating the gadget.

8. Method according to claim 1 wherein the authorization for access is given for a certain lack of time.

9. Method according to claim 1 wherein the primary file is an XML file and the features comprise Javascript® code.

10. Gadget container (36) hosting features to be implemented into a primary file (35) of a gadget, such primary file (35) being received from a Web hosting server (40) upon request by the gadget container (36), wherein the gadget container (36) comprises:
Means for retrieving the primary file (35) of the gadget with a signature, based on public/private key encryption system, associated therein,
Means (50) for controlling, with a public key of the public/private key encryption system, the signature associated to the gadget primary file,
Means for authorizing or refusing the access to the library's (44) features depending on whether it accepts or refuses the signature associated within the primary file.

11. Method according to claim 1 wherein the primary file (35) requiring access to features hosted in a library (44) of a gadget container (36) in order to implement these features for its operation, comprises a signature (16), based on public key (24)/private key (14) encryption system, associated therein in order to implement the method.
